(19) United States
(12) Patent Application Publication
(10) Pub. No.: US 2017/0193569 A1
(43) Pub. Date: Jul. 6, 2017

(54) Three dimensional web crawler

(71) Applicant: Brandon Nedelman, Oceanside, CA (US)

(72) Inventor: Brandon Nedelman, Oceanside, CA (US)

(73) Assignee: Brandon Nedelman, Oceanside, CA (US)

(21) Appl. No.: 15/368,672

(22) Filed: Dec. 5, 2016

Related U.S. Application Data
(63) Continuation of application No. 14/961,866, filed on Dec. 7, 2015, now abandoned.

(51) Int. Cl. G06Q 30/02; G06F 17/30

(52) U.S. Cl. CPC G06Q 30/0277; G06F 17/30864

(57) ABSTRACT

The invention is a computer process in which a web crawler or other type of search process views visual media files on the World Wide Web, and initially scans or downloads the files contained in html or otherwise backend internet web site files. The process identifies objects in the visual media content as being mass production items, and places the said shape or object into a series of hierarchical shape categories using product identifying attributes or features. When the object is placed into a final level of the said hierarchy, it is identified with a product identity. Product identity is specific production item specifications such as make, model, sub model, and production time period. The process also validates or verifies the product identities in visual media files that appear to deviate from the 3-dimensional database reference archive. The archive is built from scanning real life items and also using a wide collective array of visual media files available on the internet, to develop a 3-dimensional reference archive. When within a network or network of multiple networks, enough information about collective patterns in product identity deviations from the reference database has been collected and analyzed; an effort is made to use those statistics to calculate origins or sources of counterfeit distribution lines through user accounts in online networks. Visual media content is placed into a second database with associations pertaining to physical product identities located within the visual media content. The said database is referenced and integrated into individual consumer end user interface device and computer entertainment networks. Physical product identity view information correlated to visual media views are factored into a multitude of factors within an online display advertising network to accurately target more relevant and display commercials, as they pertain to individual end user devices.

### SUMMARY OF INVENTION

The process is one in which a web crawler or process within a visual media hosting service scans videos, images, or visual media, identifies objects or shapes, identifies a product identity for the shapes, and uses the product identity information to correctly target display advertising, and track counterfeit sellers online. The archived information also may be integrated into a product identity-specific search engine, in which a user query is used to display visual media files containing specific product identities that have been identified in the visual media.

### TECHNICAL PROBLEM

Two main problems exist in internet marketing and product sales/logistics today. The problems are as follows:

1. There is ineffectiveness with modern display advertising in terms of relevance. Often, an advertiser will pay a lot of money to advertising networks in hopes of return in product sales. It is the advertising networks duties to relevantly integrate the visual advertising into a display system that accurately targets the displays to users who are likely to purchase the brand or product based on their internet usage history. While at times effective for certain types of products or brands, it is often ineffective for other brands and products because it does not account for brand identity or product views in production items within visual media. A specific user is more prone to purchase or not purchase certain brands or products in display advertising based on previous views of products and brands, in non-advertising visual media.

2. There exists in online marketplaces, a large volume of countries who with complete and utter disregard to world international property laws, produce and continue to produce and sell counterfeit designs and products internationally, through global marketplaces such as eBay and Amazon. The government executive ineffectiveness allows fraudulent and counterfeit sellers to print or produce counterfeit items and sell these counterfeits to vendors. The vendors then distribute and sell these counterfeits in online marketplaces. This allows third parties, the “counterfeiters” to generate large amounts of income through numerous lines of distribution, without compensation for the rightful owners of the designs or products which are being counterfeited, and sold.

### SOLUTION TO PROBLEM

The invention solves problem 1, by establishing a means of tracking and calculating previous product views in individual consumers within one or more advertising networks, and integrates the product or brand views into a system which accurately targets more effective and relative display advertising, from paying companies, based on brand and product recognition in marketing.

The invention solves problem 2 by using statistics from online uploaders of counterfeit items, within visual media, to accurately pinpoint the source of the counterfeit production and sales, globally, from within an online marketplace.

### ADVANTAGEOUS EFFECTS OF INVENTION

The invention provides an effective means of both combating counterfeit in online marketplaces, and a means of solving inefficiencies in the online media advertising and marketing world.

The process is one in which a web crawler crawls the internet for images and videos, locates products in the content, identifies the manufacturer and model specifications of the products, and archives the relationships in a database which can be tied to individual user viewing history for counterfeit detection and advertising retargeting. The archived relationships can also be used within a user interface search engine, which displays results for queries about specific product identities contained within visual media.

The object database catalog is created from a scanning process of real life objects, which are utilized to create catalogs and databases of real life 3-dimensional production items and data relationships prior to the web crawl process. The said object database also uses additional visual online media to establish the full archive of 3 dimensional models. The products must be scanned into the archive in a systematic fashion. Solely relying on information already available on the internet will probably not suffice.

The archive of products does not necessarily have to be an open-brows able user interface or online marketplace, and may be a backend structure that is not directly presented to an end user. The invention addresses the potential of a database not publicly visible to end users, in a marketing advertising context. The invention also addresses a visible end user search catalog of product identities in the context of a shopping online marketplace.

A product attribute is a specific product identity characteristic used in the three-dimensional scanning process of visual media that is product identity specific. The three-dimensional scanning process of visual media is product identity specific. Product attributes include packaging, geometry, bar code types, and other “item specific” features on the physical appearance of a three-dimensional object. This patent also notates the “categorization” of items by product attributes of a three-dimensional object. This patent also notates the “categorization” of items by product attributes, which is a key element of the claimed invention, in the sense that the “shape hierarchies” are based partially on the existence of product attributes within the three-dimensional models.

Product attributes identify a product identity or category by referencing a logo shape or pattern to a database, and using the said as a unique product identifier. Certain product attributes are essential in the process of validating and identity and a special algorithm must be used in the process. They differ from standard vector graphics because although may have geometric elements, are “other visual product identifiable features”. For example, color, a luster native to a guitars finish, a serial or bar code, size, etc.

The process includes the identification and archiving of physical shapes of objects, and logos which are inherent shapes in the objects. The process claimed is complete with, utilization within a visual media hosting server, in which external pages do not necessarily have to be crawled for the scanning process. For example, if the visual media files are located on one server, there is no need to utilize a web crawler to scan internal files, unless the archive is being maintained periodically. In this sense, the process would not fall under the strict definition of a web crawler, but would rather fall under another search and index process style crawl.

The process is also complete with either the visual media hosting service, or web crawler, in which establishes and verifies the product identity, and uses end-user or consumer information (cookies, browser history, etc.) within an advertising network to correctly retarget advertising based on previous item views. The video hosting service is claimed separate from a crawler because many visual media hosting services have an integrated advertising network exclusive to the hosting service, where as an advertising network such as yahoo or Bing is, “an advertising network over many websites” that relies solely on cookies for its display relevance. Both visual media advertising within a hosting service and external advertising do not account for previous product views in visual media.

The said method of “tracking” or storing and presenting a user's product history views, along with a method of determining a shaped discrepancy based on an accurate scan of an object in visual media, can allow internet authorities to pinpoint sources of fraudulent and counterfeit sellers, globally. It can also be used in marketing context to accurately target and retarget relevant advertisements that consumers are more likely to purchase, because the advertisements were accounted for using previous product views, brand identity, etc. While the advertising network does not necessarily know certainly the end user's opinion about a brand or product based on prior product views, it can conclude and accurate estimation based on many factors, which include previous product views in non-advertisement visual media.

The advertising service may also recommend affiliated recommendations for new visual media, films, motion pictures, etc., who are associated or otherwise sponsored with product information. The said advertising network will recommend the motion pictures or media after factoring specific product view information pertaining to the end user or device.

The objects in visual content are identified by placing the objects in shape categories to determine what type of product they are, using image or geometric recognition technology. The entire object is mapped out using 2 dimensional to 3-dimensional mapping, a process which converts a flat picture in a video into a 3-dimensional graph. The mapping process both can be used to verify an objects product identity, and is accurate enough to the point where it can verify an objects product identity while notating a misshaped item, that does not fit the data base archive exactly, so a potentially counterfeit or damaged production item can be identified. This process occurs when enough information has been determined to correctly identify the product, however, the geometric shape recognition is so accurate to the point where after or consistent with verification of the product identity, a miss-shape is determined.

The previous paragraph is referred to as “product image noncompliance”. Repeated patterns of collectable statistics indicative of counterfeit sources is derived from user information of visual media uploads containing instances of product image noncompliance.

The 3 dimensional representations are compared to a database containing 3 dimensional models of product designs, and when a design is matched, the product is correctly identified with manufacturer and model specifications. This process is repeated for all objects in the image or video, and the information about the products represented or contained within the visual content is archived in a database. The reason for archiving the relationships is for a future simplified and fast accessibility to the relationship information.

The process of shape validation is vector-based. The vector program is the key factor in validating or disputing the production identity. The accuracy of the program must be precise, to compensate for poor quality uploads, similar designs, etc., that could result in a miscalculation of product elements. Non-vector product elements or attributes can be calculated in the process similarly to derive product identification.

### Technical Components: Hardware/Software Mechanics/Infrastructure:

One or more servers;

One or more databases;

One or more computers;

One or more networks;

One or more visual media hosting services;

One or more web crawlers;

One or more search engines;

One or more processes of object recognition in visual media;

One or more methods of 2-dimensional representation to 3-dimensional modeling conversion;

One or more processes of image recognition;

One or more processes of shape recognition;

One or more processes of classifying shapes in a hierarchy of shape categories;

One or more processes of 2-dimensional display conversion into 3-dimensional model graphing;

One or more processes of product identification;

One or more processes of media view and product identities contained in the media, being linked, identified together, corresponded, or correlated;

One or more processes of indexing archiving or storing media view and product identity information contained within the media;

One or more end user search engines capable of searing for product identities in objects in visual media;

One or more processes of identifying an end user's previous visual media/product identity data viewing history;

One or more processes of utilizing the end user's previous visual media/product identity data viewing history;

One or more processes of targeting display advertising based on previous visual/product identity views to end users;

One or more processes of identifying shape discrepancies and disfigurements of a confirmed product identity in visual media;

One or more processes of collecting statistics about shape discrepancies and disfigurements of end user visual media uploads to one or more visual media hosting services;

One or more processes of identifying counterfeit product sellers based on collected statistics about end user visual media uploads containing product shape discrepancies;

### Technical Processes:

The following paragraphs are descriptions of the processes and sub processes that comprise the invention, where each paragraph represents one step of the process.

### Outline of the Entire Process:

This section, A, outlines the entire step by step process in a brief simplified overview. The bolded/underlined phrases are summaries of the descriptions of the steps stated before it.

1. Visual media files on the internet are scanned (by the crawler process or hosting service internally) and objects are identified in the visual media. This occurs after the videos have been uploaded. This step involves a crawler for external advertising networks, or a process internal to a visual media hosting service that may or may not include a crawler.

Product Items are Located in Pictures or Videos.

2. Objects are identified as being a specific production item (product identity) based on their shape (shape and image recognition) as it is matched in a database containing the image and product specification data.

Products are Identified with Manufacturer and Model Specifications.

3. Information about visual media, and product identity of objects stored in the media, are both stored together in a database. (For example, video A contains product a, b, and c, and Image b contains product d)

Information About Pictures/Videos and Products in Them are Stored in a Database.

4. This step is comprised of the following three steps, a, b, and c

A. Information about visual media and the product identities contained in the visual media is now utilized in a search engine for product identity objects in visual media.

One can Search for Specific/Physical Products as They Appear as Objects in Visual Media.

B. Information about visual media and product identities contained in visual media is now utilized in end user's internet history for advertising purposes.

Previous Product Views of Individual Consumers can be Used for Advertising Targeting.

C. Information about visual media and product identities contained in visual media is now utilized in shape discrepancy statistics from uploaders and viewers, of visual media, to track counterfeit sellers online.

People Who Upload Counterfeit Products can Help Us Find Fraudulent Manufacturers.

### Process Overview Consists of:

the following sections, define an overview of the processes involved with the invention:

1. An online visual media hosting service that initially scans uploaded videos using 2 dimensional and 3-dimensional image recognition and product identity verification technology to identify product identity of objects found in user uploaded visual media content.

2. A web crawler that scans external sources, other than the visual media hosting server and database, (as well as periodically the internal source/hosting service) for visual media content hosted from external servers and databases and discovers product identity information about objects found in the visual media content.

3. A procedure of storing and archiving information about all visual media content and product identity paired, as they correspond to each other, information, found both internally on the visual media hosting service and externally on other visual media hosting sources as discovered by the crawler

4. A procedure of maintaining individual user, device, and IP address information containing information about the visual media/product identity view information as it pertains to the user, device, or IP address.

5. A procedure of storing on the user's browser, information containing the visual media view/product identity view information, in the form of a cookie.

6. A procedure of utilizing user, device, and IP address information as prescribed in section 4 above, and browser information containing visual media/product identity view information, as prescribed in section 5 above, to integrate into an online visual and textual display advertising network to more relevantly target display and textual advertising within the advertising network.

7. A procedure of validating shape discrepancies in objects in the visual media content scanned with the image recognition technology, and using generalizations and statistics about online user history located in the browsers and servers to track and identify counterfeited sellers and marketplaces on the World Wide Web.

### Processes

the following sections describe the technical process step by step

### Image and Video Hosting Service

the following paragraphs outline the video hosting service processes:

A. THE WEB SERVICE INITIALLY SCANS UPLOADED CONTENT TO IDENTIFY OBJECTS WHICH ARE IDENTIFIED AS PRODUCTION ITEMS (NON HUMAN, NON PLANT, PRODUCTION DESIGNS)

{This section begins the loop or repeat for each object contained in the visual media, which may be in the same or different, or overlapping frames (if the visual media is a video)}

B. A DETERMINATION IS MADE IF 2D OR 3D MODEL GRAPHING IS SUFFICIENT TO IDENTIFY PRODUCT IDENTITY, FOR THE SAID OBJECT.

C. 2D OR 3D MODELING IS USED AND REFERENCED TO DATABASE CONTAINING PRODUCT IDENTITY AND 2D/3D GRAPHIC IMAGES. A DATABASE REFERENCE IS USED TO ESTABLISH THE FIRST PRODUCT CATEGORY.

{This section marks the loop: begin repeat for each product image category as necessary for said object}

D. OBJECT PLACED INTO CATEGORY BASED ON SHAPE GENERALIZATION.

{This section marks the end of the loop or repeat for each product image category as necessary}

E. OBJECT IS PLACED INTO FINAL SHAPE CATEGORY, WHICH IS SPECIFIC CONSISTENT WITH SHAPE RECOGNITION, IN TERMS OF ACCURACY, TO ESTABLISH PRODUCT IDENTIFICATION.

F. PRODUCT IDENTITY OF OBJECT IS CONFIRMED.

{This section marks the end loop or repeat for repeat for each object within the visual media image or video: all production items have been identified in the said visual media file.}

G. GIVEN VISUAL MEDIA IMAGE OR VIDEO CONTENT IS IDENTIFIED WITH PRODUCT IDENTITY INFORMATION.

H. INFORMATION ABOUT VISUAL MEDIA AND PRODUCT IDENTITY INFORMATION CONTAINED IN VISUAL MEDIA IS STORED AND ARCHIVED IN A DATABASE, AS A RELATIONSHIP.

I. WEB CRAWLER REPEATS ALL ABOVE STEPS TO ARCHIVE DATA FOR VISUAL MEDIA EXTERNAL TO VISUAL MEDIA HOSTING SERVICE. THE EXTERNAL SCANNING PROCESS OF VISUAL MEDIA INVOLVES A WEB CRAWLER, HOWEVER THE INTERNAL SCANNING PROCESS OF VISUAL MEDIA MAY OR MAY NOT INVOLVE A WEBCRAWLER.

### Advertising Targeting Using Product Identity/Media Views:

The following paragraphs comprise the processes of advertising targeting as they relate to this invention.

1. END USER OR CONSUMER VIEWS VISUAL MEDIA FILE ON THE INTERNET

2. MEDIA VIEW INFORMATION AND ASSOCIATED PRODUCT IDENTITY INFORMATION IS STORED/LINKED TO USER IN ANY OF THE FOLLOWING WAYS:

A. USER IS LOGGED INTO A VIEW HISTORY MAINTAINING ACCOUNT, WHICH MAY BE INHERENT IN A VISUAL MEDIA HOSTING SERVICE, OR SOCIAL MEDIA SERVICE.

B. COOKIES CONTAINING THE PRODUCT IDENTITY/VISUAL MEDIA VIEW INFORMATION ARE STORED IN ANY OF THE FOLLOWING:

1. BROWSER HISTORY, VIEWABLE BY THE SERVICE OR NETWORK,

OR

2. COOKIES LEFT IN BROWSER.

C. A/THE NETWORK STORES INFORMATION ABOUT THE SYSTEM INCLUDING IP ADDRESS, DEVICE IDENTIFICATION, OR OTHER INFORMATION USED TO ASSOCIATE AND LINK PRODUCT IDENTITY AND VISUAL MEDIA VIEWS WITH THE TECHNICAL COMPONENTS OF THE USERS BROWSING/VIEWING SYSTEM.

3. DISPLAY ADVERTISING CALCULATES MORE EFFICIENT DISPLAY ADVERTISING PRIOR TO, DURING, OR CONSISTENT WITH VIEW OF OTHER CONTENT WITHIN SERVICE OR NETWORK USING A, AND OR B, AND OR C.

### Process of Counterfeit Identification Based on Shape Discrepancy Statistics:

The following paragraphs outline the process of counterfeit identification in visual media statistics inherent in the invention:

{this section marks the repeat or loop for each end user uploaded visual media containing a discrepancy, identified as being a potential counterfeit production item.}

A. VIDEOS ARE NOTATED WITH PRODUCT DESIGN SHAPES THAT DEVIATE FROM ARCHIVED PRODUCT IDENTITY DATABASE. THE SHAPE IDENTIFICATION PROCESS IS ACCURATE ENOUGH TO PLACE THE OBJECT INTO A FINAL SHAPE CATEGORY, OR PRODUCT IDENTITY CATEGORY, WHILE NOTATING DISCREPANCIES WHICH MAY INDICATE THAT THE ITEM WAS COUNTERFEIT.

B. INFORMATION ABOUT USER BROWSING AND PURCHASE HISTORY IS SCANNED FROM AVAILABLE SOURCES. THIS MAY INCLUDE COOKIES, BROWSING HISTORY, SEARCH HISTORY, AND ANY OTHER INFORMATION COLLECTED CONSISTENT WITH THE STANDARD OPERATIONS OF THE NETWORK OR SERVICE. SPECIFIC INFORMATION WHICH THIS STEP ATTEMPTS TO COLLECT INCLUDES END USER USE/BROWSING OF SPECIFIC WEB SITES, MARKETPLACES, AND SPECIFIC USER ACCOUNTS/SELLERS ASSOCIATED WITH THE SPECIFIC WEBSITES AND MARKETPLACES.

{This section marks the end loop or repeat for each end user visual media piece containing a shape discrepancy.}

C. INFORMATION FROM A AND B ARE ARCHIVED IN A DATABASE.

D. GENERALIZATIONS ARE CONFIRMED BY PROCESS PERTAINING TO SIMILAR SCENARIOS RELATING TO MIS SHAPED ITEMS. INFORMATION USED IN THIS PORTION OF THE PROCESS INCLUDES USER STATISTICS ABOUT SHAPE DISCREPANCIES AND SPECIFIC, USER ACCOUNTS, SELLERS, WEBSITES, AND ONLINE MARKETPLACES, THAT CAN BE USED TO FORM A DEDUCTION ABOUT PARTICULAR AND SPECIFIC ONLINE SELLERS.

E. SELLER OR ONLINE MERCHANT IDENTIFIED WITH MIS SHAPED PRODUCTS BASED ON GENERALIZATIONS.

F. PROPER AUTHORITIES AND OR RIGHTFUL OWNERS OF THE PRODUCT DESIGN ARE NOTIFIED OF THE ABOVE INFORMATION AS IT PERTAINS TO COUNTERFEIT SELLERS, TO AID IN PROSECUTION AND OR LITIGATION.

### 3. Technical Hardware Configuration:

The following paragraphs outline the technical hardware configuration as it relates to the software and hardware used in the processes of the invention: All internet networks are integrated into the world wide web, which is a large network consisting of all of the internet networks in the world.

1. The visual media hosting service is active on a server connected to an internet network.

2. The crawler is active on a server connected to an internet network.

3. The archiving database is active on a server that receives data from the web crawler.

4. The search engine user interface and database is active on a server connected to an internet network.

5. The visual media is hosted on an internal hosting service, or external hosting sources, on servers connected to internet networks.

6, External visual media is hosted on different servers within the internet network.

7. The crawler connects to the World Wide Web, via the internet network to crawl all visual media internal and external available on the World Wide Web.

8. The search engine is connected to the archive database to return archive results (of visual media related to objects and product identities).

4. Search Engine Process (Consistent with Archiving of Product Identity Relationships in Visual Media):

The following sections outlines the process of the user interface search engine, of which a user query for a specific product identity returns search results of specific visual media containing the product identities:

1. Product identities are archived in database with corresponding visual media information.

2. The search engine is connected to the archive database.

3. The end user types in query to search for visual media files pertaining to specific product identities within the visual media files.

4. The search engine looks for query terms, or tags relationships, in the said database containing the archived information about visual media files and the product identities contained within them.

5. The visual media files containing exact product identities physically located within the visual media files are displayed as search results for the query. The search results contain visual media files, containing product identities of objects in the files that have been scanned and verified to a specific product identity.

### 5. Process of Visual Media Scanning, Object/Product Identification, Archiving Relationships:

the following sections contains the processes related to visual media scanning, product identity verification, and the archiving of the relationships between the visual media files, and the product identities contained within. The bolded words briefly break down and summarize the text that follow in these paragraphs.

1. Scanning. Visual media is initially scanned in the hosting server upon upload or after upload, and visual media is crawled by a crawler, which may include online analysis or downloading the visual media file offline prior to the analysis or scanning of the visual media file.

2. Analysis. Objects are identified using shape and or image recognition technology to identify that the object contained within the visual media file is indeed a production item, and not a plant, animal, or otherwise non production item.

3. Further analysis: Object is mapped out to 3-dimensional graphic model is necessary. Object is placed in a categories and subsequent categories of shapes until product identity is verified.

4. Repeat for all objects in video. Above steps 2 and 3 are repeated for all objects in video.

5. Media and product pairing. Media is paired with product identities contained within.

6. Archiving. Media and object/product identity relationships are cataloged in a database for future reference by search engine, and for ad targeting based on user viewing histories.

### Process of Web Crawling for Visual Media

the following paragraphs prescribe and outline the process of crawling for internal and external visual media files.

1. Crawler goes through an index of web pages.

2. Crawler goes through all linked pages in an index of web pages.

3. Consistent prior to, during, or after steps to and 3, crawler views and/or downloads visual media files on web pages.

4. Crawler identifies products and objects in visual media and archives the information about the visual media and its product and object identity relationships in a database, for future use by search engine and for ad targeting.

### Ad Targeting

the following paragraphs outline the use of product identity information for advertising targeting purposes in an advertising network that is internal or external.

1. User views visual media containing product identities.

2. Information about user views is stored in some way.

3. Product identity information about the visual media previous user views is used to target display advertising.

1. Shape discrepancy is identified in a piece of visual media that is inconsistent with its product identity.

2. Information is crawled on linked pages about user(s) statistics.

3. Statistic information added to an archive.

4. Repeat all of the above for more shape discrepancies in each piece of visual media.

5. Statistics from all shape discrepancies in all visual media, with all user(s) statistics is used to identify potential counterfeit sellers of product designs online.

### Video 3d Mapping Process

the following paragraphs outlines and describes the three-dimensional mapping process pertaining to objects contained in visual media files:

1. Object identified in video.

2. 3-dimensional estimate of exact product shape is created from appearance of object.

3. As object moves or rotates, 3-dimensional projection is further formed as individual clips and frames are set in time.

4. Final shape of design is identified in the reference archive.

### Glossary of Terms

This section contains brief definitions of technical terms that one may need to use for reference in the context of this patent, to better clarify the method(s) that are claimed.

1. Product view—a marketing term which relates to how often a specific product is viewed in visual advertising. When somebody views a particular product in visual media, it is counted as one product view per piece and instance of visual media.

2. Brand recognition—a marketing concept where a member of an audience develops a liking (or the opposite) to a particular brand he or she becomes familiar with in display advertising, picture, or video internet adverting. Brand recognition is a traditional marketing concept that originates since the early days of mass media, and is also prominent and recognized in realms other than the World Wide Web, such as television and radio advertising.

3. Counterfeit—a mass production term that describes a product design that was printed or produced by someone other than the product designs rightful owner, or one who has otherwise not acquired the proper licensing and permission to use the design. Many countries house counterfeit producers of designs, and export these items globally via internet marketplaces. Often, counterfeit items are “look-alikes” that resemble the item they are attempting to copy, but are defective in quality. Many counterfeit producers and sellers offer false warranties online, and are impossible to contact in the common event of a malfunction which occurs with their counterfeit products.

4. Visual media—a picture or video file viewed or downloaded on the internet, via a web browser application or otherwise program that accesses the said file via the internet.

5. 3 dimensional—existing on a visual plane of 3 dimensions (for example, real life vision, or a calculator that graphs on 3 planes).

6. Model—a graphic representation that is mapped out, or calculated by a machine. The model can be viewed as a visual display (a graphic coordinate representation viewed through a display apparatus, monitor, etc.), or can be just memory that is stored by the machine or computer, but not physically viewed as a display.

7. Visual media hosting service—a website designed for the sharing, viewing, and uploading of media files, such as youtube.com.

8. Product identity-make, manufacturer, model, sub model, and production date specifications of a mass produced product.

9. Database—a machine or computer that stores memory, or files. A database is used to store information for internet operations, such as website back ends, or computer programming files, and all user data associated with the website. For example, Google, the search engine, uses many extremely large databases to store the files that make up how their websites operate, and all data associated with it.

10. Shape categories—a product image can be recognized by a machine if it falls into shape parameters. In my invention, a hierarchy of shape categories is used to narrow down the object to a specific product identity.

For a simple example, an object would first be identified as being a “guitar” in first shape category, second would be identified as being a “flying v style guitar” in second shape category, and third and finally would be identified as “Gibson flying v 1989 standard” which is the final, most narrow, product identity shape category.

11. Web crawler—a bot, or program, that browses the entire internet for all websites and their linked pages, and stores the content in an index, or database. Crawlers are used to identify content that exists on the internet for later returned results in search engines, from the archive. Standard crawlers browse and store text information from the html front end file of web pages, but they are also capable or integratable into a process which downloads or views visual media files.

12. Advertising network—a network of interconnected websites displaying advertising from a common server, whose sites and advertising hosts have the ability to view information about the customer as they view the site and advertising content. Some advertising networks such as yahoo are external from a visual media hosting service, and rely solely on cookies and browser information to determine relevant display advertising. Google ad sense, is also said external from a visual media hosting service at times, but is integrated internally in situations into the YouTube network, in which a user account is factored into relevant display advertising. The internal advertising also uses cookie information, but is slightly more accurate than the external advertising network because of additional factors such as location and user account history.

13. Architectural—relating to buildings.

14. Automotive'relating to cars.

15. Shape recognition—the process in which a machine is able to take a given shape and identify it with a matching shape in a database.

16. Object—shape or figure in visual media. It is the predecessor for a shape category. The system may ignore certain objects such as trees and animals, as it is looking to categorize and classify production items specifically.

17. Device—phone or computer.

18. IP address—unique identifying number assigned to a router or device.

19. Shape discrepancy—a product shape that deviates from the archived product shape or design, but is still identifiable as matching the said product identity as the closes match. This is the basis for the establishing a potential counterfeit item in a piece of visual media that has been uploaded to the internet.

20. Browser—program used to view web content, in the form of an html web page or another web site or web page format.

21. Cookie—a file left in the web browser containing information about previous consumer website and media views.

22. Server—a computer or database.

23. Network—connected servers, databases, file systems, or computers, such as an internal network or the internet.

24. End user—consumer using a website, service, or application online.

25. Image recognition—the process in which a machine is able to take a given image and identify it with a matching image in a database.

### BRIEF DESCRIPTION OF DRAWINGS

FIG. 1 is an overview/outline of the entire invention as a whole.

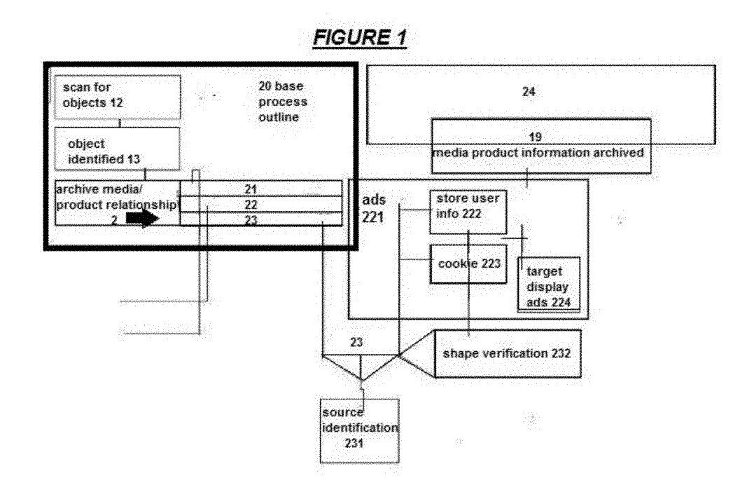

FIG. 2 is a breakdown of the scanning/identity process as it pertains step by step, to each object located in a piece of scanned visual media.

FIG. 3 is an illustration of how a vector program scans and calculates the geometric aspects of an object located in a piece of visual media. In this example, the glasses worn on the man's face have been identified by the algorithm as being a potential object. The vector dimensions are being depicted as being calculated, by the white lines, so they can he used as parameters in the described invention, to pinpoint a specific product identity, of the “object”, or “glasses”.

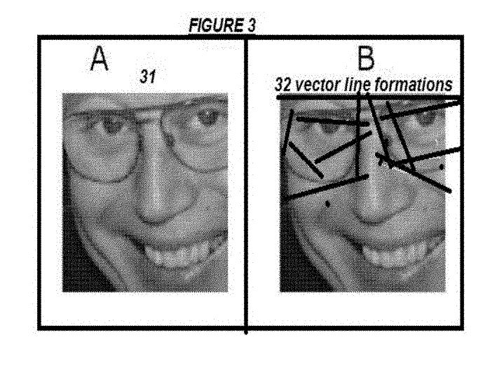

FIG. 4 outlines how the product identities are used within an advertising network/marketing context, as described in the invention.

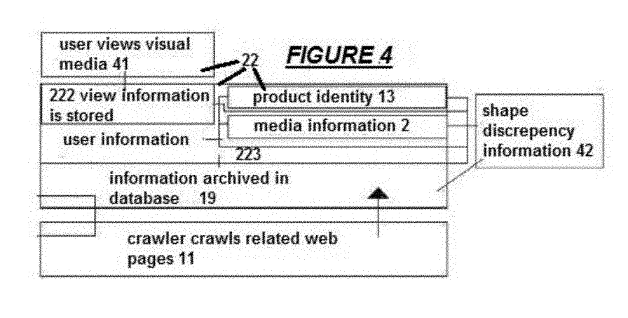

FIG. 5. Is, like FIG. 1, a base outline of the entire invention, however, emphasizing different elements from a different scope.

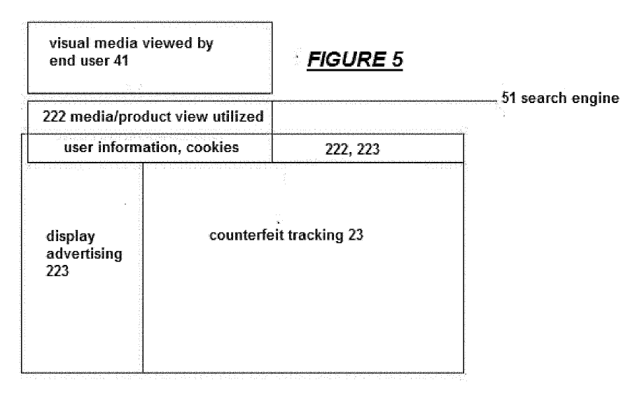

FIG. 6 is the video 3d mapping process.

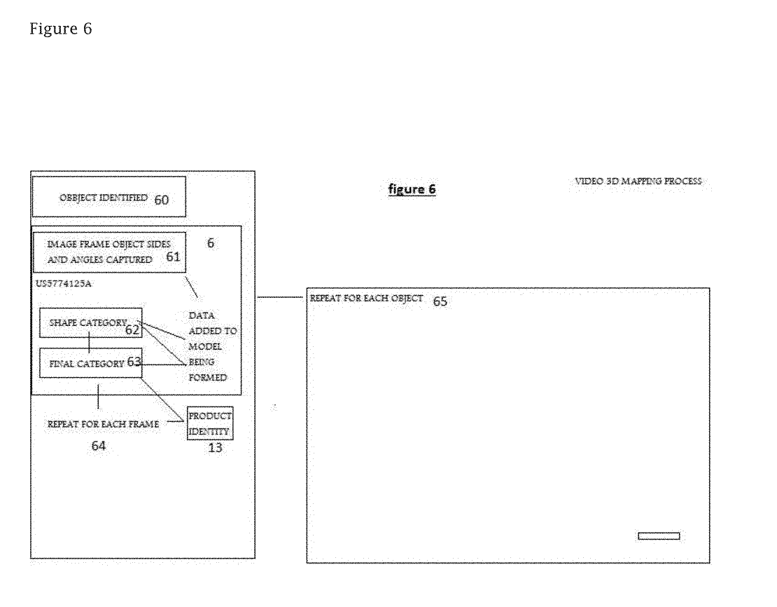

### EXPLANATION OF FIGURES CONTAINED IN DRAWINGS

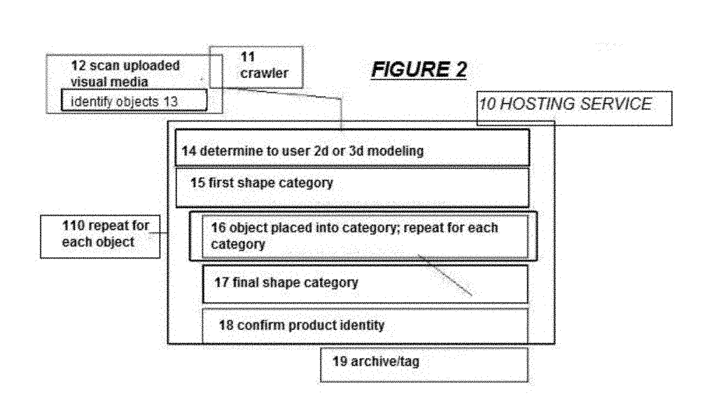

20 is the base process outline/overview, wherein 12 objects are scanned in videos and a product identity is established for the said object, 13. FIG. 2 outlines uses/applications of the assembly which are a user-search engine 21, an advertising network/system 22, and a counterfeiter tracking system 23. 41 the visual media is viewed by the end user. In the ad network 22, advertisement relevant display operation is inherent 221. This consists of targeted visual display advertisements for an end user on the internet. 222 stores user information such as cookies 223. Product identity information about viewed visual media content such as videos is integrated and calculated from the visual content to calculate or generate the relevant advertising 224. It occurs as follows.

41, the user views a video or image through likely a web browser, or other software interface 13, the product identity is established for all product objects in the video, and 2, the media information is tagged with it 19. 222 the view information is stored about the product identity/visual media information, and 223 the information is stored in the users identifying market/interface such as a user account service or browser cookies.

23 is the counterfeit tracking system. Sellers or sources 231 are calculated using shape discrepancies or vector validated discrepancies from visual media content, which is indicated by 232. 11 is the web crawler. 24 The crawler scans and identifies product identities of objects in videos, 12 and 13 accordingly. The information about the visual media scanned content is archived with its product identity information in a database or archive, 19. Both counterfeit product occurrence in visual media, and the actual identification/validation of a product identity, utilize shape verification/misconfigure calculation, which is 42.

110 Product identification for each object occurs as follows. 14 a determination is made to use 2d or 3d modeling. 15, the said of 14 is used to put the given or first object into a first shape category. Eventually after descending the categories 16, as the model is further scanned or validated, the object is placed into final shape or product identity category 17. The product identity has been confirmed now, 18. The information about the visual media scanned content is archived with its product identity information in a database or archive, 19.

31 figure a is a sample of visual media containing an object glasses; FIG. 32 b is the scanning of the said object to establish a product identity.

51. A search engine can receive a user text query and display visual media results using product identity information about objects contained in the database of visual media content, which is displayed to the search end user through the search engine browser or interface.

60 is the initial scan of a to be-identified object. 6 outlines the scanning process of a moving object. The object is placed into a first shape category 62, and eventually a final shape category 63. Each frame utilizes the box 6, 61, 62 until the object has been identified with a product identity as 13. The said process is repeated for each object in the picture or video, 65.

1. A process in which:
Visual media files are scanned for objects;
Objects are located in the visual media files;
And product identification is established for the located objects.

2. process of claim 1 wherein the visual media files are retrieved for scanning by an automated computer or data process.

3. The process of claim 1 wherein 2-dimensional scanning is used.

4. The process of claim 1 wherein 3-dimensional scanning is used.

5. The process of claim 1 wherein 2 dimensional and 3-dimensional scanning is used.

6. The process of claim 1 wherein the retrieval is performed by a web crawler.

7. The process of claim 1 wherein the retrieval is performed by a process integrated or internal to the software and/or hardware components and processes of a visual media hosting service.

8. The process of claim 1 wherein the product identification of objects is accomplished by comparing, validating or verifying geometric, vector, or shape data of scanned objects against geometric, vector, or shape data from a database, to establish product identification based on the comparison

9. The process of claim 1 further comprising that:
Data is derived pertaining to specific scanned visual media content of/with determined product identities contained within it; and
The derived data is stored in an archive or database.

10. The process of claim 6 wherein the web crawler periodically or systematically crawls and/or re-crawls the world-wide web for the retrieval of visual media content for scanning

11. The process of claim 7 wherein the scanning is performed to content initially upon its upload from end users to the server.

12. The process of claim 7 wherein the scanning of visual media content is periodically performed inherent with and associated with a systematic review of the stored contents of the hosting services file storage or server.

13. The process of claim 8 further comprising that additional non-shape or geometric values determined of a scanned object are objects are partially or wholly utilized integrally for establishing product identification.

14. The process of claim 8 further comprising the steps that:
Data is collected from a base or plurality of end users based on scenarios of upload of visual media containing product objects that have been identified with a product identity, but are non-compliant or otherwise mis-matched, mis-shaped, or disfigured from specific values of the correct database match;
Additional data collected of the same end user base is utilized for relevant data derivations pertaining to online websites or marketplaces utilized by the end user base; and
Data is derived from the collected data from the plurality of end user's indicative to specific online sources sellers or marketplaces wherein the distribution of said non-compliant or otherwise mis-matched, mis-shaped, or disfigured object shapes that were contained in the end user uploaded content may have been derived.

15. The process of claim 8 further comprising the steps that:
Data is collected from a base or plurality of end users based on scenarios of upload of visual media containing product objects that have been identified with a product identity, but are non-compliant or otherwise mis-matched, mis-shaped, or disfigured from specific values of the correct database match;
Additional data collected of the same end user base is utilized for relevant data derivations pertaining to online websites or marketplaces utilized by the end user base; and
Data is derived from the collected data from the plurality of end users indicative to specific online sources sellers or marketplaces wherein the distribution of said non-compliant or otherwise mis-matched, mis-shaped, or disfigured object shapes that were contained in the end user uploaded content may have relevant or relative to the actual source of derivation.

16. The process of claim 9 wherein the stored derived data pertaining to contained product identities within specific scanned visual media content is further utilized with an advertising network for generation and/or displaying relevantly targeted display advertising to an end user based on the derived data.

17. The process of claim 9 further comprising the utilization of said derived data in the context of a search engine wherein upon user text query to the search engine, search results are presented to the end user pursuant to the text query:
Wherein returned search results are visual media;
Wherein returned visual media search results are associated with product identities contained in the visual media content;
Wherein the search results are returned based on search/text correlation to either text values of the specific visual media content, the specific product identities contained within the visual media content, and/or the combination of both said.
